(19) United States
(12) Patent Application Publication
(10) Pub. No.: US 2006/0098939 A1
(43) Pub. Date: May 11, 2006

(54) Combination system capable of controlling each device through a single OSD menu and method thereof

(75) Inventor: Hong-Gu Han, (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/983,702

(22) Filed: Nov. 9, 2004

(51) Int. Cl. H04N 5/91

(52) U.S. Cl. 386/46

(57) ABSTRACT

A combination system comprises a first environment storage part for storing data relating to an environment setup of the first device, a second environment storage part for storing data relating to an environment setup of the second device, a first controller for setting an environment of the first device by referring to the data stored in the first environment storage part, a second controller, the second controller for setting an environment of the second device by referring to the data stored in the second environment storage part, and an input device for receiving and transferring an environment setup command to the first controller. The first controller stores the environment setup command in the first environment storage part when the input environment setup command relates to the environment setup of the first device, and the first controller transfers the environment setup command to the second controller.

### BACKGROUND OF THE INVENTION

1. Field of the Invention

The present invention generally relates to a combination system. More particularly, the present invention relates to a combination system, which combines a plurality of devices having independent functions, such as a digital versatile disk player (DVDP) and a video cassette recorder (VCR).

2. Description of the Related Art

A “combination system”, which combines more than two devices having independent functions into one system, is referred to as a “combo system” or a “combo” in short. For example, a digital video disc player and video cassette recorder (DVDP/VCR) combo system combines the functions of the DVDP with those of the VCR

FIG. 1 depicts a conventional DVDP/VCR combo system and its peripherals. The DVDP/VCR combo system 10 includes a VCR part 11 and a DVDP part 12. The VCR part 1 performs the functions of the general VCR. This includes, for example, reproducing video and audio previously recorded on a magnetic tape and recording on the magnetic tape a signal received from external sources. The DVDP part 12 performs the functions of the general DVDP. This includes, for example, reproducing video and audio recorded on a DVD.

The DVDP/VCR combo system 10 is connected to a television (TV) 23, which is a peripheral for outputting the video and audio reproduced by the DVDP part 12 or the VCR part 11. The DVDP/VCR combo system 10 is connected to an audio amplifier 21, which is a peripheral for outputting the audio reproduced by the DVDP 12. An external device 25, such as a camcorder, may be connected to the DVDP/VCR combo system 10. The DVDP/VCR combo system 10 receives and records and/or reproduces video and audio from the external device 25.

The VCR part 11 and the DVDP part 12 of the DVDP/VCR combo system 10 are integrally constructed in a single casing. Accordingly, the DVDP/VCR combo system 10 is a single device in appearance. A user can change the operation mode and operate the individual function of the VCR part 11 and the DVDP part 12 by using a separate input device, such as a remote controller 15, or an operation panel (not shown) disposed on a front side of the DVDP/VCR combo system 10.

The conventional combo system 10 as above has an on-screen display (OSD) block (not shown) for providing the user with a selection menu through an OSD function. If the user initially selects the OSD function to input a command by using the remote controller 15, a list of operation commands, which can be input by the user, is displayed on the TV 23. Accordingly, the user can facilely control the desired operation through the list. The list of operation commands includes the general operations of the DVDP part 12 or the VCR part 11, such as a record/play, a stop, a fast forward, and a rewind. In addition, the list includes commands relating to the setup environment of the VCR 11, for example, setup commands relating to a language type of a subtitle.

However, since the OSD function of the conventional combo system 10 is provided to each of the DVDP part 12 and the VCR part 11, the user may experience inconvenience and be confused in using the OSD function. Specifically, there are OSDs, respectively, for the DVDP part 12 and the VCR part 11. When the user intends to set the environment of the VCR part 11 through the OSD function using the remote controller 15, it is necessary to use the OSD provided for the VCR part 11. In order to set the environment of the DVDP part 12, the user has to use the OSD provided for the DVDP part 12. As a result, when setting the environment of the VCR part 11 in the DVD mode, the user needs to firstly change the operation mode of the combo system 10 to the VCR mode.

When setting the environment or inputting the operation, which is common to the DVDP part 12 and the VCR part 11, for example, when inputting the command for the reproduction operation or the setup command for the language, the user is likely to input the command without noting that the current operation mode is the DVDP mode. Thus, even though the user intends to input the command for setting the language of the VCR part 11 to English, instead the DVDP part 12 may be set to English. In addition, even though the user intends to input the command for the play operation of the VCR part 11, that of the DVDP part 12 may be performed instead.

### SUMMARY OF THE INVENTION

To address the above disadvantages of the conventional arrangement, an aspect of the present invention provides a combo system capable of providing convenience with respect to an environment setup of each part, which independently operates in the combo system.

Consistent with the above aspect of the present invention, the combination system combines first and second devices each operating independently. The combination system comprises a first environment storage part for storing data relating to an environment setup for the first device, a second environment storage part for storing data relating to an environment setup for the second device, a first controller for setting an environment of the first device by referring to the data stored in the first environment storage part, a second controller capable of transferring and receiving a command to and from the first controller, the second controller for setting an environment of the second device by referring to the data stored in the second environment storage part, and an input device for receiving and transferring an environment setup command to the first controller. The first controller stores the environment setup command in the first environment storage part when the input environment setup command relates to the environment setup of the first device, and the first controller transfers the environment setup command to the second controller so that the environment setup command is stored in the second environment storage part when the input environment setup command relates to the environment setup of the second device.

The combination system further comprises first and second OSD blocks for outputting first and second OSD views, respectively, which provide a list of the operation commands that can be input for operating each of the first and second devices. The environment setup command can be retrieved through one of the main OSD views of the first and second OSD views.

The first and second devices are disposed in a single casing, the first device is a video cassette recorder (VCR) recording and reproducing a signal on and from a magnetic tape, and the second device is a digital versatile disc (DVD) player reproducing a signal recorded on a DVD. The input device is one of an operation panel for receiving an operation command from a user or a remote control sensor for receiving the operation command from the user through a remote controller.

Typically, the combination system combining the DVDP and the VCR uses a VCR controller as the main controller. According to an embodiment of the present invention, the user can set the environment with respect to both of the VCR part and the DVDP part using a single OSD view. Thus, there is no need to perform unnecessary operation such as an operation mode change, and the undesired operation of the user is prevented.

### BRIEF DESCRIPTION OF THE DRAWING FIGURES

These and other aspects and advantages of the invention will become apparent and more readily appreciated from the following description of exemplary embodiments, taken in conjunction with the accompanying drawing figures of which:

FIG. 1 is a block diagram of a conventional DVDP/VCR combo system;

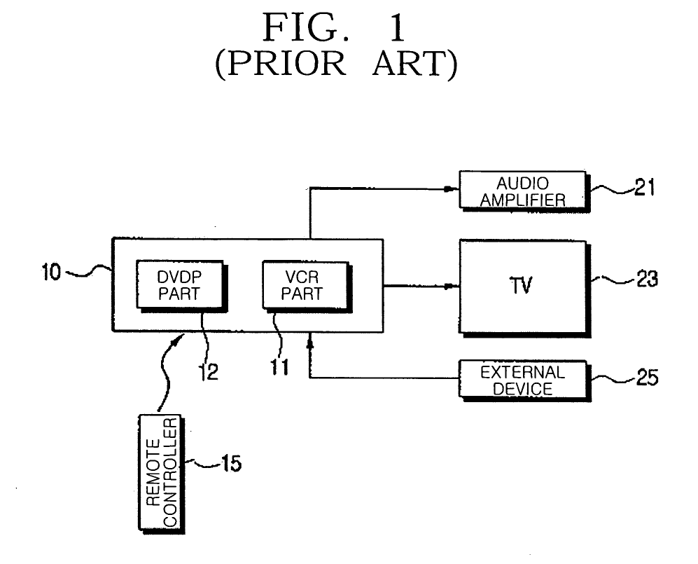

FIG. 2 is a block diagram of a DVDP/VCR combo system according to an embodiment of the present invention;

FIG. 3 is a flowchart of an operation of the DVDP/VCR combo system according to an embodiment of the present invention;

FIG. 4 is a view of an example of a menu view displayed on a television (TV) by an OSD block of the DVDP/VCR combo system of FIG. 2; and

FIG. 5 is a view of another example of the menu view of FIG. 4.

### DETAILED DESCRIPTION OF THE EXEMPLARY EMBODIMENTS

Reference will now be made in detail to exemplary embodiments of the present invention, examples of which are illustrated in the accompanying drawings, wherein like reference numerals refer to the like elements throughout. The embodiments of the present invention are described below in detail by referring to the drawings.

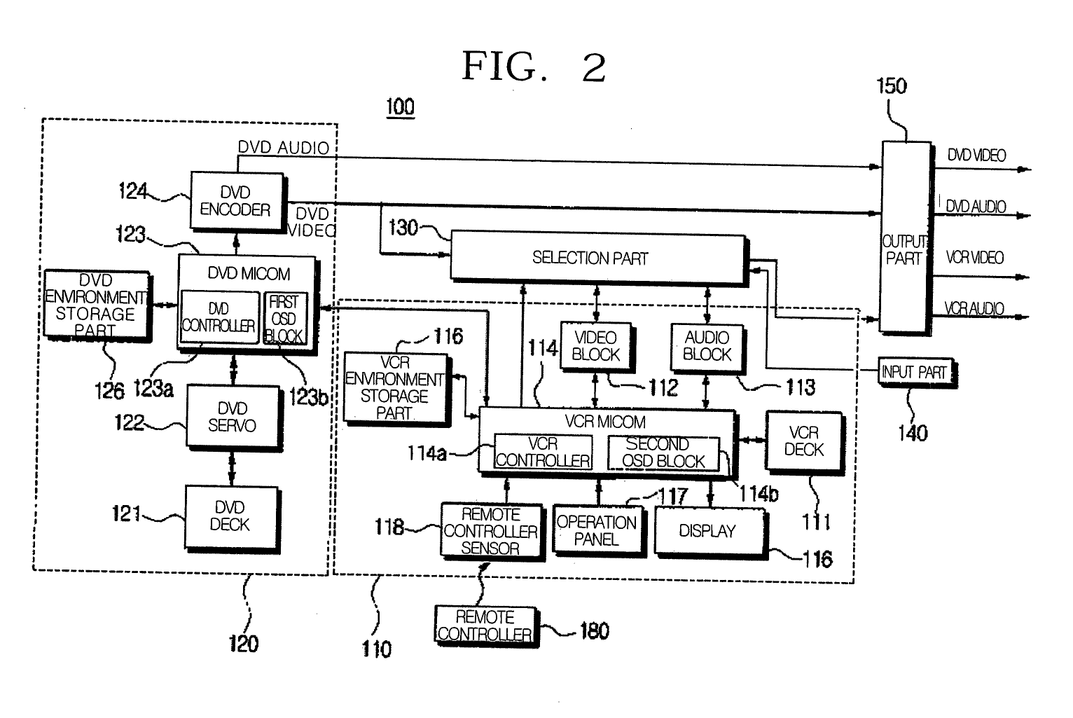

FIG. 2 is a block diagram of a digital versatile disc player and a video cassette recorder (DVDP/VCR) combo system 100 capable of performing the functions of a DVDP and a VCR according to an embodiment of the present invention.

Referring now to FIG. 2, the DVDP/VCR combo system 100 includes a VCR part 110 for performing functions of a general VCR, a DVDP part 120 for performing functions of a general DVDP, a selection part 130 for performing a selection operation with respect to signals output from the VCR part 110 and the DVDP part 120, an input part 140 for providing the selection part 130 with a signal input from an external device, such as a camcorder or the like, and an output part 150 for providing the signals output from the VCR part 110 and the DVDP part 120 to an external device, such as a TV, display and an amplifier.

The DVDP part 120 preferably comprises a DVD deck 121, a DVD servo 122, a DVD micom 123, and a DVD encoder 124. The DVD deck 121 reads data recorded on a DVD so as to reproduce data stored on the DVD. The DVD servo 122 controls a position and a speed of the DVD deck 121. The DVD encoder 124 receives the data read by the DVD deck 121 through the DVD micom 123 and outputs the DVD video and audio data.

The DVD micom 123 preferably comprises a DVD controller 123a and a first on-screen display (OSD) block 123b. The DVD controller 123a controls overall operations of the DVD deck 121, the DVD servo 122, and the DVD encoder 124. The first OSD block 123b generates an OSD view added to the video reproduced by the DVD part 120.

The VCR part 110 includes a VCR deck 111 for recording or reproducing a signal on or from a magnetic tape, video block 112 and audio block 113 for transmitting and receiving video and audio to be recorded or reproduced by the VCR deck 111, and a VCR micom 114 for controlling overall operations of the VCR deck 111, the video block 112, and the audio block 113. The VCR part 110 further includes a display 119 for displaying information on an operation state and an operation mode to a user, an operation panel 117 for receiving commands from the user, and a remote controller sensor 118 for receiving commands from the user through a remote controller 180.

The VCR micom 114 includes a VCR controller 114a and a second OSD block 114b. The VCR controller 114a controls the operations of the parts of the VCR part 110. The second OSD block 114b generates an OSD view added to the video reproduced by the VCR part 110. The OSD view generated by the second OSD block 114b is used as a main OSD view including a view change command, which will be explained in more detail below.

The VCR controller 114a and the DVD controller 123a are connected to each other to transfer and receive the commands therebetween. That is, a command input to the VCR controller 114 may be transferred to the DVD controller 123a, and vice versa

The VCR part 110 and the DVDP part 120 include a VCR environment storage part 116 and a DVD environment storage part 126, respectively. The VCR environment storage part 116 and the DVD environment storage part 126 store data relating to the environment set values of the VCR part 110 and the DVDP part 120, respectively.

The selection part 130 receives the output of the DVD encoder 124, the outputs of the video block 112 and the audio block 113, and the signal from the input part 140. The selection part 130 performs the selection operation with respect to the input signals under the control of the VCR controller 114a. The output of the selection part 130 is input to the output part 150.

The output part 150 receives the signals from the DVD encoder 124, the selection part 130, and the second OSD block 114b, and outputs signals relating to a DVD video, a DVD audio, a VCR video, and a VCR audio. The output part 150 is connected with a peripheral such as a TV, a display, a sound device or similar devices, which output the video and/or the audio.

The input part 140 is communicably connected to the selection part 130. The input part 140 transfers a signal input from external sources to the selection part 130. A signal output terminal of an external device, such as a camcorder or the like, is connected to the input part 140. Accordingly, a signal recorded in the external device can be transferred to the combo system 100 through the input part 140, and can be recorded on the magnetic tape using the VCR part 110 or reproduced through a TV or other output device.

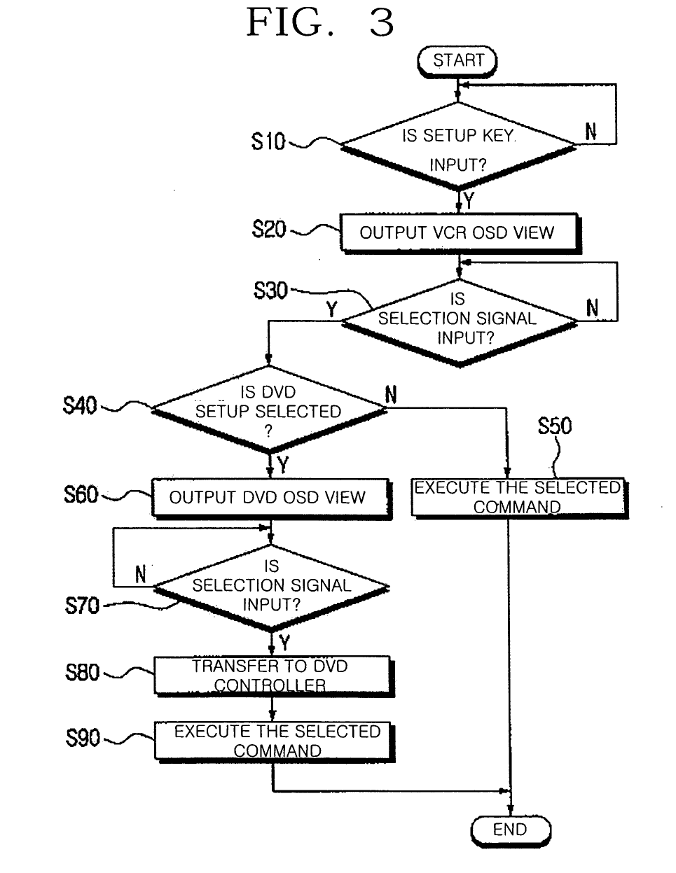

FIG. 3 is a flowchart of a control operation of the combo system 100 according to an embodiment of the present invention. Referring to FIG. 3, when the user presses a setup key disposed on the remote controller 180 (S10), the remote controller sensor 118 receives and transfers a setup command to the VCR controller 114a. The VCR controller 114a sends a command instructing to input the OSD view to the second OSD block 114b. The second OSD block 114b outputs the OSD view displaying a list of operation commands (S20). The list of the operation commands is displayed as the OSD view on a screen of a TV or similar device connected to the output part 150.

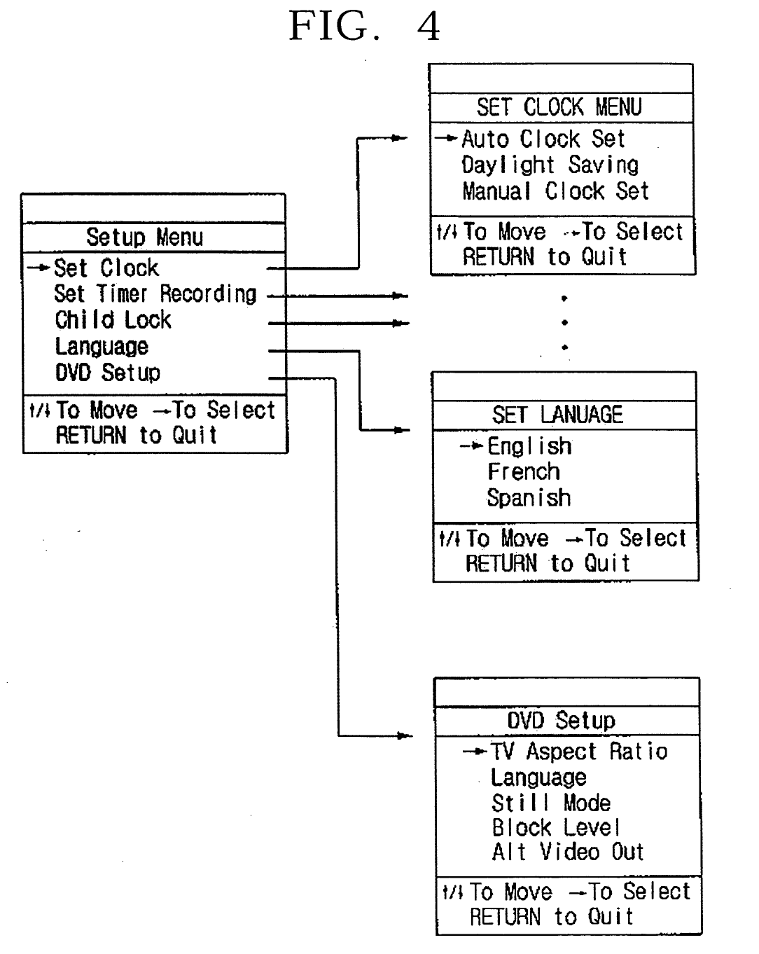

An example of the list of the operation commands displayed as the OSD view is shown in FIG. 4. FIG. 4 depicts an environment setup menu view and sub-menu views. The environment setup menu view is displayed when the user presses the setup key of the remote controller 180. The sub-menu views are displayed when the user selects items on the setup menu view.

Still referring to FIG. 4, a main view displays items of the operation commands for setting the environment of the VCR part 110, that is, a “Set Clock” item for setting a time and a “Language” item for setting the language. The main view also displays items of a view change command for changing an output view to the OSD view output by the fist OSD block 123b, that is, a “DVD Setup” item. Each item corresponds to the menu view providing sub-items. For example, the “Set Clock” item corresponds to a sub-menu view including items such as an “Auto Clock Set” item for automatically setting the time and a “Manual Clock Set” item for manually setting the time. The “Language” item corresponds to a sub-menu view including items such as “English”, “French”, and “Spanish” items for selecting the language.

The “DVD Setup” item corresponds to a main menu view for setting the environment of the DVD part 120. If the user selects the “DVD Setup” item, the main menu for the environment setup of the DVD part 120 is displayed, which includes items such as “TV Aspect Ratio”, “Language”, “Still Mode”, “Black Level”, and “Alt Video Out” items.

Accordingly, the user can set the desired environment by selecting the items of the main menu views and the sub-menu views in sequence.

When the user selects a selection signal to input by using the remote controller 180 (S30), the selection signal is input to the VCR controller 114a. If the input selection signal is the command relating to the environment setup of the VCR (S40), the VCR controller 114a controls the VCR part 110 to execute the input command (S50). If the selection signal is the command relating to the setup of the DVD (S40), the VCR controller 114a transfers the command to the DVD controller 123a. Upon receiving the DVD setup command, the DVD controller 123a controls the first OSD block 123b to generate the DVD setup menu view. The generated menu view is transferred to the VCR controller 114a. The VCR controller 114a provides the received DVD setup menu view to the second OSD block 114b. The second OSD block 114b outputs the DVD setup menu view (S60). Thus, the DVD setup menu view, as shown in the right lower portion of FIG. 4, is displayed on a display device, such as a TV, connected to the output part 150.

The user inputs the selection command selected among the operation commands through the DVD setup menu view. When the selection command is input by the user (S70), the VCR controller 114a transfers the input selection command to the DVD controller 123a (S80). The DVD controller 123a controls the DVD part 120 to execute the selected command (S90).

If the selected command relates to the operation of the DVD part 120 such as a play operation, the command is executed. If the command relates to the environment setup of the DVD, the DVD controller 123a stores the environment setup data input by the user in the DVD environment storage part 126. In the same manner, the command selected at step S30 relates to the environment setup of the VCR part 110, the VCR controller 114a stores environment setup data input by the user in the VCR storage part 16.

According to an embodiment of the present invention, it is possible to control both of the VCR part 10 and the DVDP part 120 through the single OSD view because the VCR part 110 is controlled through the main OSD view and the DVDP part 120 is controlled by selecting the “DVD Setup” item on the main OSD view. Therefore, it is possible to retrieve the list of the desired operation commands irrespective of the current mode. In addition, erroneous operations are prevented from operating the undesired part.

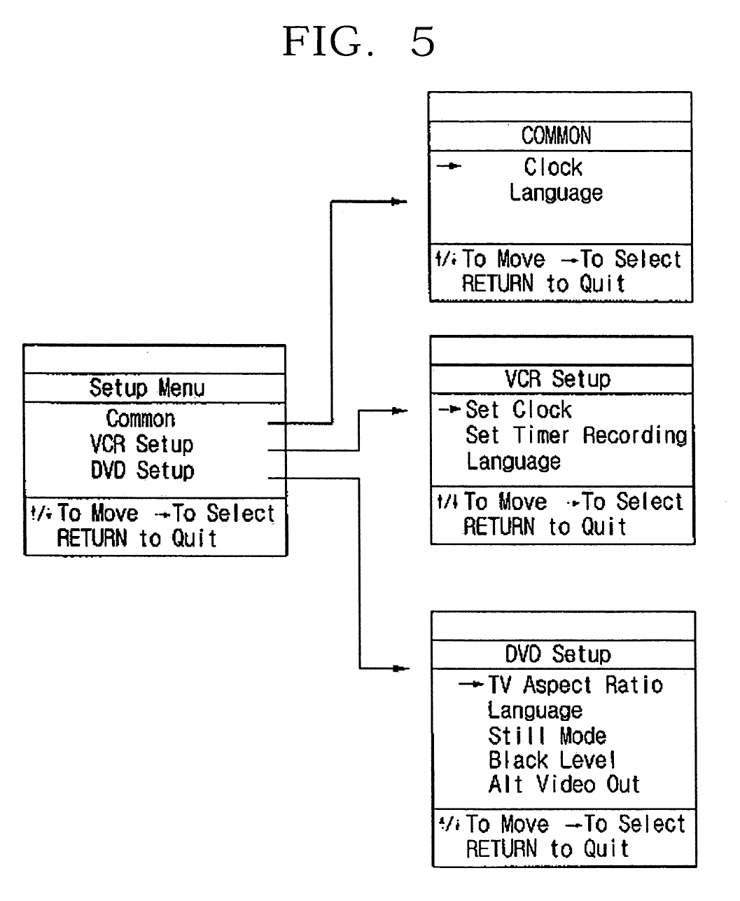

FIG. 5 is another example of an environment setup menu view and sub-menu views. Referring to FIG. 5, the main OSD view provided from the second OSD block 114b displays a “Common’ item for displaying a list of operation commands common to both of the VCR part 110 and the DVDP part 120, a “VCR Setup” item for displaying the list of the operation commands of the VCR part 110, and a “DVD Setup” item for displaying the list of the operation commands of the DVDP part 120. The user can selectively retrieve the operation commands of the DVD part 120, the VCR part 110, or for both of the parts 110 and 120 on the initial view.

In light of the foregoing, since one of the controllers of a plurality of the devices receives and executes the command relating to the environment setup, the user can facilely set the environment as desired without having to separately change the operation mode. Hence, the number of the button selections required by the user is reduced and it is more convenient for the user to utilize the combo system 100.

While the exemplary embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

What is claimed is:

1. A combination system combining first and second devices each operating independently, the combination system comprising:
a first environment storage part for storing data relating to an environment setup of the first device;
a second environment storage part for storing data relating to an environment setup of the second device;
a first controller for setting an environment of the first device by referring to the data stored in the first environment storage part;
a second controller capable of transferring and receiving a command to and from the first controller, the second controller for setting an environment of the second device by referring to the data stored in the second environment storage part; and
an input device for receiving and transferring an environment setup command to the first controller,
wherein the first controller stores the environment setup command in the first environment storage part when the input environment setup command relates to the environment setup of the first device, and the first controller transfers the environment setup command to the second controller so that the environment setup command is stored in the second environment storage part when the input environment setup command relates to the environment setup of the second device.

2. The combination system of claim 1, further comprising first and second on-screen display (OSD) blocks for outputting first and second OSD views, respectively, which provide a list of operation commands that can be input for operating each of the first and second devices,
wherein the environment setup command can be retrieved through one of a main OSD views of the first and second OSD views.

3. The combination system of claim 2, wherein the first and second devices are disposed in a single casing, the first device is a video cassette recorder (VCR) for recording and reproducing a signal on and from a magnetic tape, and the second device is a digital versatile disc (DVD) player for reproducing a signal recorded on a DVD.

4. The combination system of claim 2, wherein the input device is one of an operation panel for receiving an operation command from a user or a remote control sensor for receiving the operation command from the user through a remote controller.

5. A method for storing environmental set up data for devices within first and second devices comprising the steps of:
storing first data relating to an environment setup of the first device in a first environment storage part;
storing second data relating to an environment setup of the second device in a second environment storage part;
setting an environment of the first device by referring to the first data stored in the first environment storage part using a first controller,
transferring and receiving a command to and from the first controller by a second controller, the second controller for setting an environment of the second device by referring to the second data stored in the second environment storage part; and
receiving and transferring an environment setup command from and to the first controller through an input device;
wherein the first controller stores the environment setup command in the first environment storage part when the input environment setup command relates to the environment setup of the first device, and the first controller transfers the environment setup command to the second controller so that the environment setup command is stored in the second environment storage part when the input environment setup command relates to the environment setup of the second device.
